(19) United States
(12) Patent Application Publication
(10) Pub. No.: US 2023/0171061 A1
(43) Pub. Date: Jun. 1, 2023

(54) REFERENCE SIGNAL OR PRECODER INDICATION FOR A GROUP OF COMPONENT CARRIERS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 17/759,842

(22) PCT Filed: Feb. 7, 2020
(86) PCT No.: PCT/CN2020/074488

§ 371 Date: Jul. 29, 2022

(51) Int. Cl. H04L 5/00

(52) U.S. Cl. CPC H04L 5/0051; H04L 5/0098

(57) ABSTRACT

Various aspects of the present disclosure generally relate to wireless communication. In some aspects, a user equipment (UE) may receive an indication relating to at least one of a reference signal or a precoder configuration, wherein the indication applies to multiple component carriers (CCs); determine respective configurations for communications on the multiple CCs in accordance with the indication; and perform the communications on the multiple CCs in accordance with the indication. Numerous other aspects are provided.

### FIELD OF THE DISCLOSURE

Aspects of the present disclosure generally relate to wireless communication and to techniques and apparatuses for reference signal or precoder indication for a group of component carriers (CCs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include receiving an indication relating to at least one of a reference signal or a precoder configuration, wherein the indication applies to multiple component carriers (CCs); determining respective configurations for communications on the multiple CCs in accordance with the indication; and performing the communications on the multiple CCs in accordance with the indication.

In some aspects, a method of wireless communication, performed by a base station, may include transmitting an indication relating to at least one of a reference signal or a precoder configuration, wherein the indication applies to multiple CCs, wherein the indication indicates respective configurations for communications on the multiple CCs; and performing, with a UE, the communications on the multiple CCs in accordance with the indication.

In some aspects, a UE for wireless communication may include a memory and one or more processors operatively coupled to the memory. The memory and the one or more processors may be configured to receive an indication relating to at least one of a reference signal or a precoder configuration, wherein the indication applies to multiple CCs; determine respective configurations for communications on the multiple CCs in accordance with the indication; and perform the communications on the multiple CCs in accordance with the indication.

In some aspects, a base station for wireless communication may include a memory and one or more processors operatively coupled to the memory. The memory and the one or more processors may be configured to transmit an indication relating to at least one of a reference signal or a precoder configuration, wherein the indication applies to multiple CCs, wherein the indication indicates respective configurations for communications on the multiple CCs; and perform, with a UE, the communications on the multiple CCs in accordance with the indication.

In some aspects, a non-transitory computer-readable medium may store one or more instructions for wireless communication. The one or more instructions, when executed by one or more processors of a UE, may cause the one or more processors to receive an indication relating to at least one of a reference signal or a precoder configuration, wherein the indication applies to multiple CCs; determine respective configurations for communications on the multiple CCs in accordance with the indication; and perform the communications on the multiple CCs in accordance with the indication.

In some aspects, a non-transitory computer-readable medium may store one or more instructions for wireless communication. The one or more instructions, when executed by one or more processors of a base station, may cause the one or more processors to transmit an indication relating to at least one of a reference signal or a precoder configuration, wherein the indication applies to multiple CCs, wherein the indication indicates respective configurations for communications on the multiple CCs; and perform, with a UE, the communications on the multiple CCs in accordance with the indication.

In some aspects, an apparatus for wireless communication may include means for receiving an indication relating to at least one of a reference signal or a precoder configuration, wherein the indication applies to multiple CCs; means for determining respective configurations for communications on the multiple CCs in accordance with the indication; and means for performing the communications on the multiple CCs in accordance with the indication.

In some aspects, an apparatus for wireless communication may include means for transmitting an indication relating to at least one of a reference signal or a precoder configuration, wherein the indication applies to multiple CCs, wherein the indication indicates respective configurations for communications on the multiple CCs; and means for performing, with a UE, the communications on the multiple CCs in accordance with the indication.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a diagram illustrating an example of signaling of a reference signal indication for a group of component carriers, in accordance with various aspects of the present disclosure.

FIG. 4 is a diagram illustrating an example of applying a reference signal indication for a group of component carriers, in accordance with various aspects of the present disclosure.

FIG. 5 is a diagram illustrating an example of signaling of one or more precoder indications for a group of component carriers, in accordance with various aspects of the present disclosure.

FIGS. 6 and 7 are diagrams illustrating examples of applying a reference signal indication for a group of component carriers, in accordance with various aspects of the present disclosure.

FIG. 8 is a diagram illustrating an example process performed, for example, by a user equipment, in accordance with various aspects of the present disclosure.

FIG. 9 is a diagram illustrating an example process performed, for example, by a base station, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

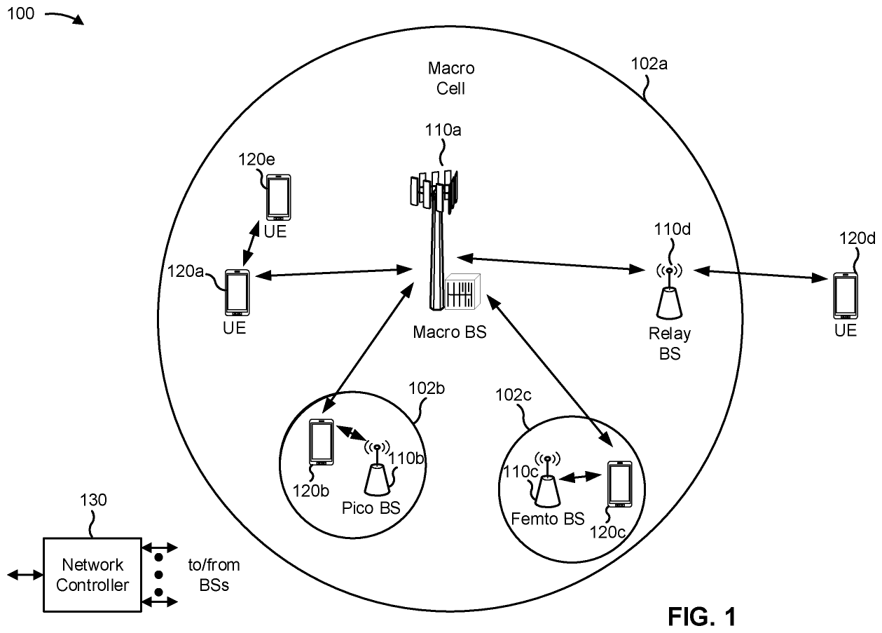

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

ABS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The term “base station,” used herein, embraces “eNB”, “base station”, “NR BS”, “gNB”, “TRP”, “AP”, “node B”, “5G NB”, “cell,” and/or the like. Furthermore, as noted above, the term “cell” can be used to refer to a base station structure for communications with a UE using a particular CC.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

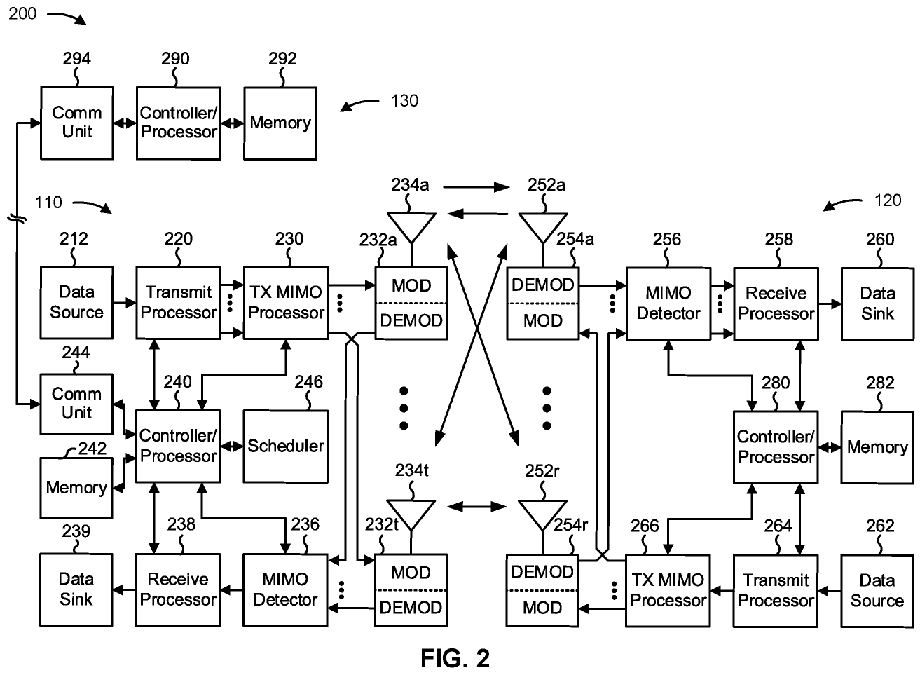

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

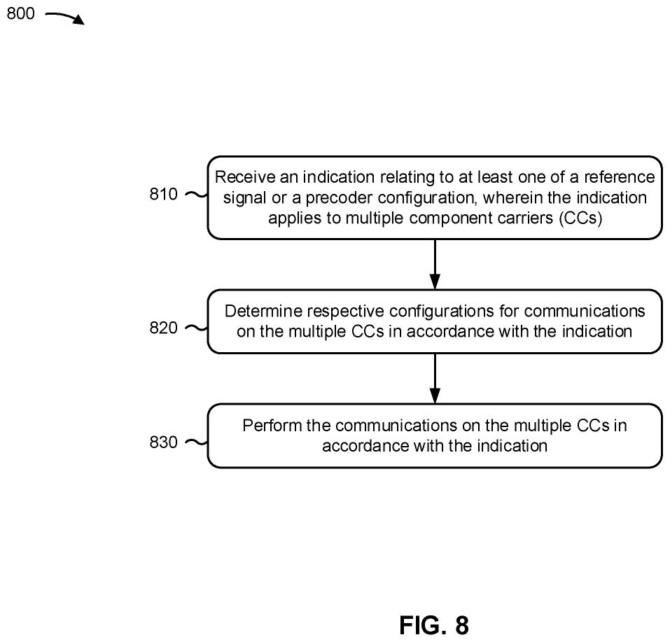

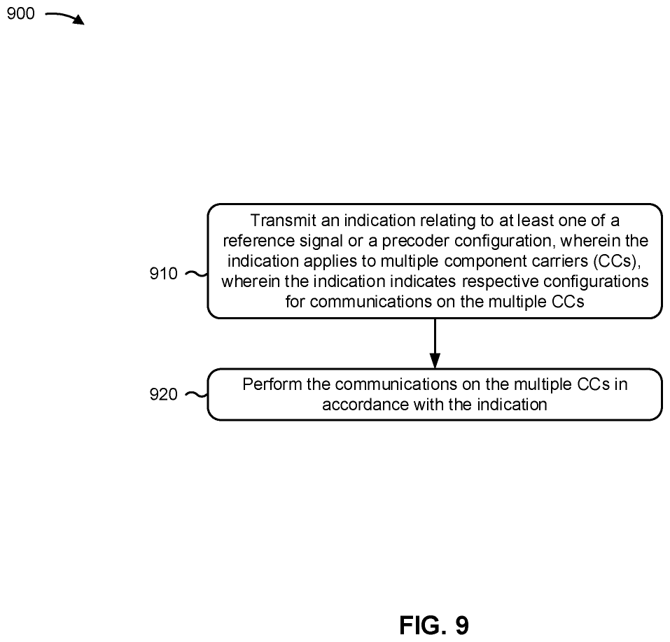

Controller/processor 240 of base station 110, controller/processor 280 of UE 120, and/or any other component(s) of FIG. 2 may perform one or more techniques associated with reference signal or precoder indication for a group of component carriers (CCs), as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed (e.g., directly, or after compiling, converting, interpreting, and/or the like) by one or more processors of the base station 110 and/or the UE 120, may perform or direct operations of, for example, process 800 of FIG. 8, process 900 of FIG. 9, and/or other processes as described herein. In some aspects, executing instructions may include running the instructions, converting the instructions, compiling the instructions, interpreting the instructions, and/or the like. A scheduler 246 may schedule UEs for data transmission on the downlink and/or uplink.

In some aspects, UE 120 may include means for receiving an indication relating to at least one of a reference signal or a precoder configuration, wherein the indication applies to multiple component carriers (CCs); means for determining respective configurations for communications on the multiple CCs in accordance with the indication; means for performing the communications on the multiple CCs in accordance with the indication; means for receiving information identifying the multiple CCs to which the indication applies; means for receiving configuration information pertaining to the multiple CCs; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting an indication relating to at least one of a reference signal or a precoder configuration, wherein the indication applies to multiple component carriers (CCs), wherein the indication indicates respective configurations for communications on the multiple CCs; means for performing, with a user equipment (UE), the communications on the multiple CCs in accordance with the indication; means for transmitting configuration information pertaining to the multiple CCs; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

NR may provide for the use of dynamic spectrum sharing (DSS). DSS enables a network operator to provide 4G and 5G access within the same spectrum, thus improving coverage and simplifying rollout of 5G services. In some cases, such as in DSS, a physical downlink control channel (PDCCH) on a secondary cell (SCell) of a UE may schedule a communication, such as a physical downlink shared channel (PDSCH) or a physical uplink shared channel (PUSCH), on a primary cell (PCell) or a primary secondary cell (PSCell) of the UE. “Cell” is used interchangeably with “component carrier” (CC) herein. For example, scheduling on multiple such cells may be performed using a single DCI, and may involve certain indications, such as a demodulation reference signal (DMRS) indicator, a precoder indication, and/or the like. However, as the number of cells scheduled by the DCI increases, so may the complexity, size, and blind decoding difficulty of the DCI.

Some techniques and apparatuses described herein provide signaling of DMRS and/or precoder indications for a group of CCs. For example, some techniques and apparatuses described herein provide group-wide (e.g., multi-CC) DMRS and/or precoder indications or per-CC DMRS and/or precoder indications. By signaling DMRS and/or precoder indications that is shared between multiple CCs of a group, size and complexity of DCI is reduced. Furthermore, by signaling per-CC precoder indications, granularity and flexibility of precoder configuration is improved.

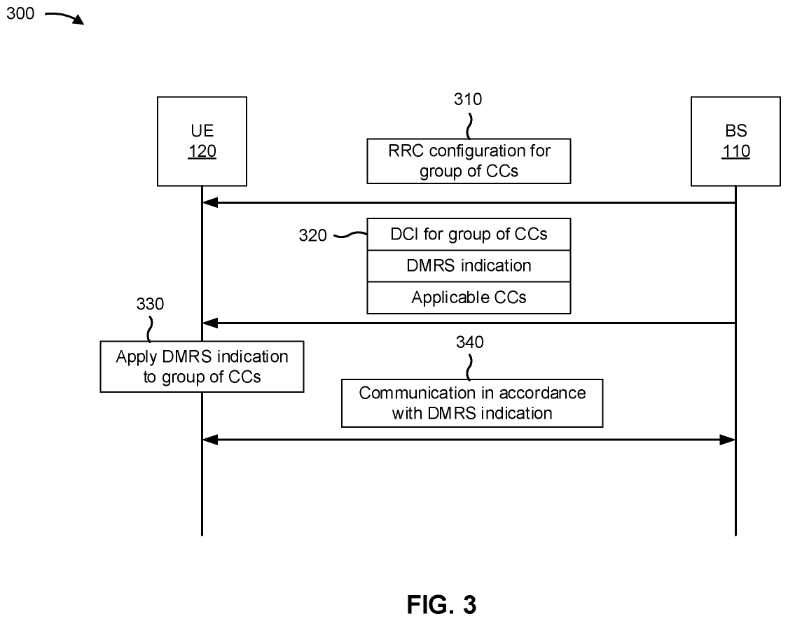

FIG. 3 is a diagram illustrating an example 300 of signaling of a reference signal indication for a group of component carriers, in accordance with various aspects of the present disclosure. As shown in FIG. 3, example 300 includes a UE 120 and a BS 110.

As shown by reference number 310, the BS 110 may provide a radio resource control (RRC) configuration for a group of CCs. In some aspects, the RRC configuration may activate or configure the group of CCs for the UE 120. In some aspects, the RRC configuration may indicate which CCs are included in the group of CCs. For example, the RRC configuration may indicate that an indication relating to a reference signal or a precoder applies to the group of CCs. In some aspects, the RRC configuration may include a DMRS configuration. In some aspects, the RRC configuration may indicate whether a transform precoder is enabled for the group of CCs on the uplink. In some aspects, the RRC configuration may indicate a DMRS type for the group of CCs (e.g., type 1 or type 2) and/or a maximum length of a DMRS, where the DMRS type and/or the maximum length relates to the uplink and/or the downlink. In some aspects, the RRC configuration may indicate a maximum number of code words schedulable by DCI (e.g., 1 or 2 codewords) for the downlink.

As shown by reference number 320, the UE 120 may receive DCI for the group of CCs. For example, the DCI may schedule an uplink or downlink communication on the group of CCs. As further shown, the DCI may include an indication relating to a reference signal (shown as a DMRS indication). The indication may include, for example, a DMRS port indication, information indicating a number of codewords on the downlink, a DMRS sequence initialization, and/or the like.

As further shown by reference number 320, in some aspects, the DCI may indicate applicable CCs for the DMRS indication. For example, in some aspects, the applicable CCs may include the group of CCs on which the DCI schedules a communication. In some aspects, the DCI may explicitly indicate the applicable CCs. Additionally, or alternatively, the B S 110 may provide information explicitly indicating the applicable CCs (e.g., using RRC signaling, medium access control (MAC) signaling, and/or the like).

As shown by reference number 330, the UE 120 may apply the DMRS indication to the applicable CCs. For example, as shown by reference number 340, the UE 120 may transmit or receive a DMRS in accordance with the DMRS indication (e.g., using a DMRS port, a number of DMRS code division multiplexing (CDM) groups, a number of codewords, and/or a DMRS sequence initialization indicated by the DMRS indication). In this way, the UE 120 may receive and apply a DMRS indication that relates to multiple different CCs, which reduces overhead and DCI size and complexity relative to providing respective DMRS indications for each CC.

Thus, a DMRS indication can be applied to multiple CCs (e.g., a multi-CC DMRS indication. The same indication may be applied to applicable CCs, with regard to DMRS port indication, number of codewords in the DL, and/or DMRS sequence initialization. For each multi-CC DMRS indication, the base station may indicate applicable CCs. In some aspects, applicable CCs may be explicitly indicated (e.g. via RRC/MAC-CE/DCI). In some aspects, applicable CCs are implicitly indicated (e.g., multi-CC DMRS indication is applied to all CCs scheduled by a single DCI). An RRC configuration about DMRS configuration may be shared between or the same for multiple CCs, with regard to transform precoder enabled or not for UL, dmrs-Type 1 or 2 and maxlength for UL and DL, or maxNrofCodeWordsScheduledByDCI 1 or 2, for DL.

As indicated above, FIG. 3 is provided as an example. Other examples may differ from what is described with respect to FIG. 3.

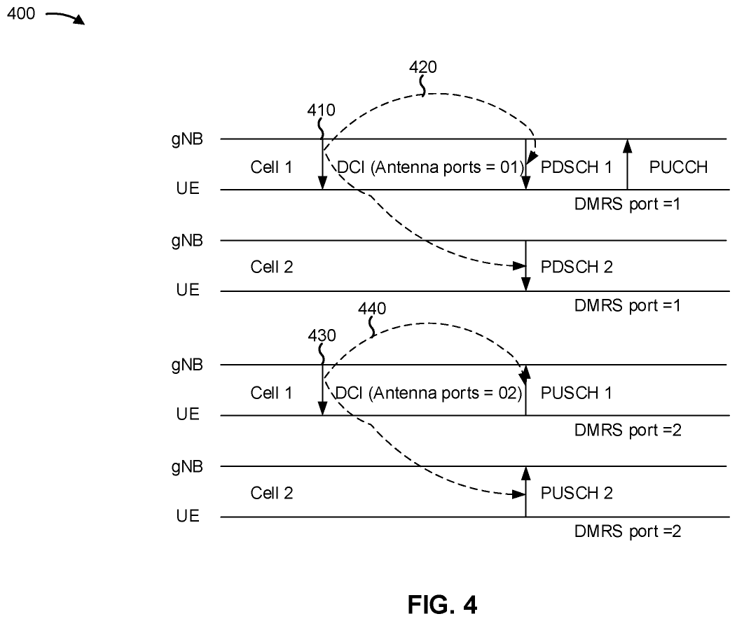

FIG. 4 is a diagram illustrating an example 400 of applying a reference signal indication for a group of component carriers, in accordance with various aspects of the present disclosure. As shown, example 400 includes a UE and a gNB (e.g., a BS 110). Furthermore, two scenarios are shown: a first scenario, shown in the top half of FIG. 4, and a second scenario, shown in the bottom half of FIG. 4.

As shown in FIG. 4, and by reference number 410, the UE may receive, from the gNB, DCI on a cell 1. As further shown, the DCI may include a DMRS indication indicating that a DMRS port configuration associated with a value 01 is to be used. As shown by reference number 420, the UE may apply the DMRS indication for a PDSCH 1 received on the cell 1 and a PDSCH 2 received on a cell 2. Thus, the UE uses DMRS port 1 for the cell 1 and the cell 2. In some aspects, the value may correspond to a particular DMRS port or a particular group of DMRS ports.

As shown by reference number 430, the UE may receive, from the gNB, DCI with a DMRS indication indicating that a DMRS port configuration associated with a value 02 is to be used. As shown by reference number 440, the UE may apply the DMRS indication for the PUSCH 1 received on the cell 1 and the PUSCH 2 received on the cell 2. Thus, the UE uses DMRS port 2 for the cell 1 and the cell 2. In this way, the size and complexity of the DCI is reduced by providing DMRS indications for two cells using a single DCI and a single indication.

As indicated above, FIG. 4 is provided as an example. Other examples may differ from what is described with respect to FIG. 4.

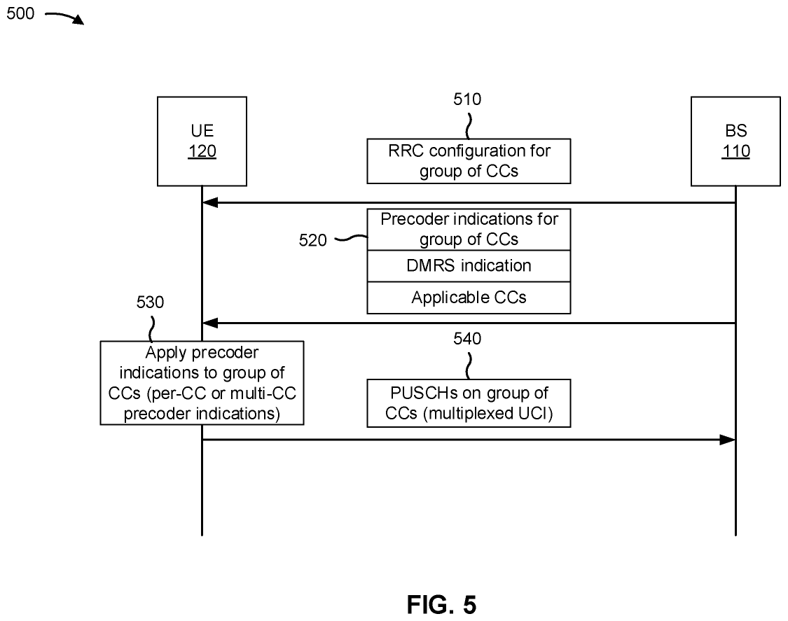

FIG. 5 is a diagram illustrating an example 500 of signaling of one or more precoder indications for a group of component carriers, in accordance with various aspects of the present disclosure.

As shown by reference number 510, the BS 110 may provide an RRC configuration for a group of CCs. In some aspects, the RRC configuration may activate or configure the group of CCs for the UE 120. In some aspects, the RRC configuration may indicate which CCs are included in the group of CCs. For example, the RRC configuration may indicate that an indication relating to a reference signal or a precoder applies to the group of CCs.

In some aspects, the RRC configuration may indicate a precoder configuration. In this case, the precoder configuration may be shared between the group of CCs or may be the same for all CCs of the group of CCs. For example, the precoder configuration may indicate at least one of a codebook subset restriction for codebook based multiple-input-multiple-output (MIMO) communication, a maximum rank for codebook based MIMO communication, a full power transmission (FPTX) mode for codebook based MIMO communication, a sounding reference signal (SRS) resource indicator (SRI) for codebook based MIMO communication, or a rank or number of layers associated with the multiple CCs or an SRS for non-codebook based multiple-input-multiple-output (MIMO) communication (e.g., an Lmax or Nsrs value).

As shown by reference number 520, the UE 120 may receive DCI for the group of CCs. For example, the DCI may schedule an uplink or downlink communication on the group of CCs. As further shown, the DCI may include an indication relating to a precoder (shown as a precoder indication). In some aspects, the precoder indication may be a per-CC precoder indication. For example, the precoder indication may include a transmitted precoding matrix indicator (TPMI) per CC of the group of CCs (e.g., for codebook-based uplink MIMO), an SRI per CC of the group of CCs (e.g., for non-codebook-based uplink MIMO), and/or the like. In some aspects, the precoder indication may be applied to multiple CCs or the group of CCs (e.g., may be a common precoder indication). For example, the precoder indication may include a TPMI that is applied for the group of CCs, an SRI that is applied for the group of CCs, and/or the like. In some aspects, the indication may apply to multiple CCs based at least in part on a value of the indication that corresponds to a table entry identifying respective values associated with the indication. For example, a codepoint of a TPMI field of the indication may correspond to multiple TPMI, and each TPMI may correspond to a CC. As another example, a codepoint of an SRI field of the indication may correspond to multiple SRI, and each SRI may correspond to a CC.

As further shown by reference number 520, in some aspects, the DCI may indicate applicable CCs for the precoder indication. For example, in some aspects, the applicable CCs may include the group of CCs on which the DCI schedules a communication. In some aspects, the DCI may explicitly indicate the applicable CCs. Additionally, or alternatively, the B S 110 may provide information explicitly indicating the applicable CCs (e.g., using RRC signaling, medium access control (MAC) signaling, and/or the like).

As shown by reference number 530, the UE 120 may apply the precoder indication to the applicable CCs. For example, as shown by reference number 540, the UE 120 may transmit or receive a communication in accordance with the precoder indication(s). In this way, the UE 120 may receive and apply a precoder indication that relates to multiple different CCs, or may receive and apply a plurality of precoder indications corresponding to respective CCs, which reduces overhead and DCI size and complexity relative to providing DCI with respective precoder indications for each CC.

As indicated above, FIG. 5 is provided as an example. Other examples may differ from what is described with respect to FIG. 5.

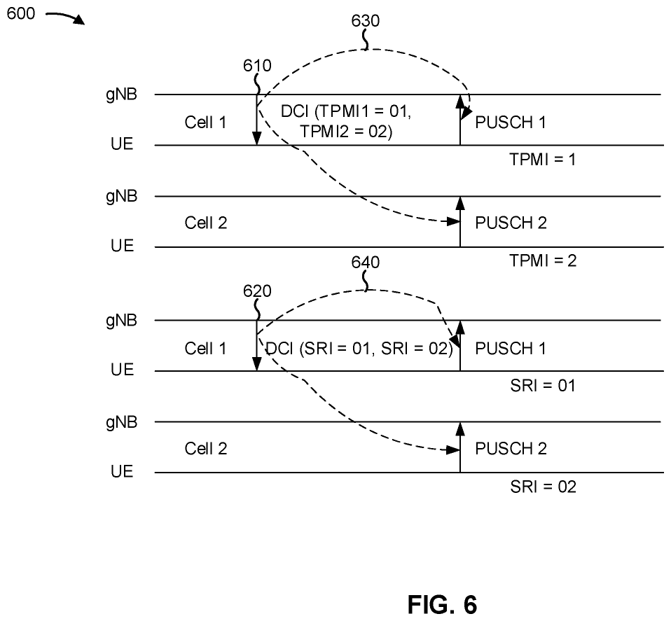

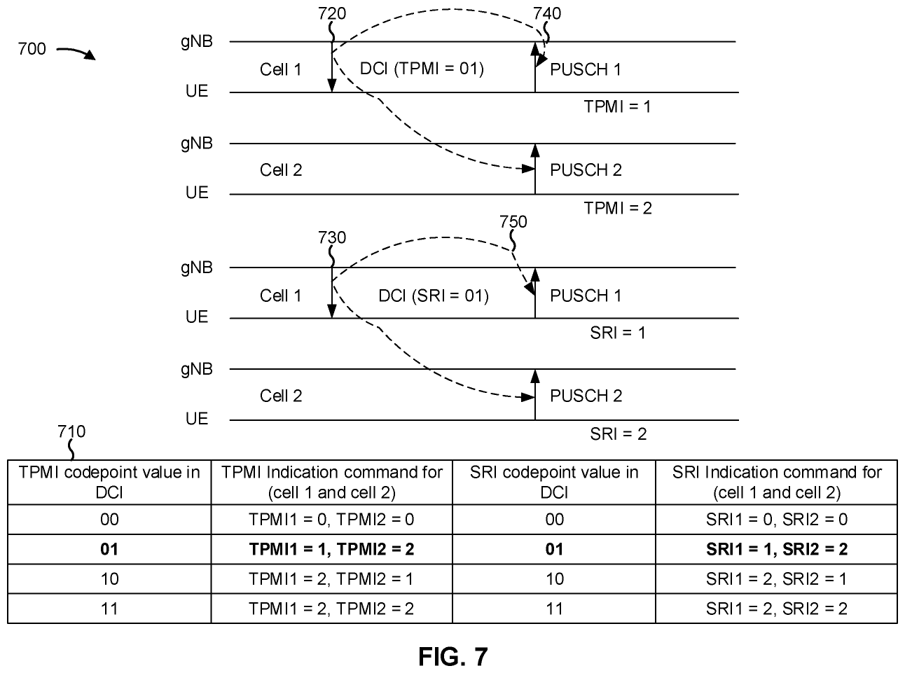

FIGS. 6 and 7 are diagrams illustrating examples 600 and 700 of applying a reference signal indication for a group of component carriers, in accordance with various aspects of the present disclosure. Example 600 is an example where precoder indications including a TPMI indicator and an SRI indicator are signaled per CC. As shown in FIG. 6, and by reference numbers 610 and 620, a UE (e.g., UE 120) may receive, from a gNB (e.g., BS 110), DCI including per-CC precoder indications. For example, the per-CC precoder indications may indicate respective TPMI values (e.g., TPMI1=01 and TPMI2=02) and respective SRI values (e.g., SRI=01 and SRI=02) to be used for a cell 1 and a cell 2. As shown by reference number 630 and 640, the UE may apply the per-CC precoder indications on the cell 1 and the cell 2.

Example 700 is an example where a UE (e.g., UE 120) uses a table 710 to determine values for precoder indications for a cell 1 and a cell 2. As shown, the table 710 indicates TPMI and SRI indication values (shown as codepoint values), and identifies respective pairs of values for the cell 1 and the cell 2 corresponding to the TPMI and SRI indication values. As shown by reference number 720 and 730, the UE may receive the precoder indications in DCI on a cell 1. As shown by reference number 740 and 750, the UE may apply the TPMI and SRI values corresponding to the precoder indications received from the gNB.

As indicated above, FIGS. 6 and 7 are provided as examples. Other examples may differ from what is described with respect to FIGS. 6 and 7.

FIG. 8 is a diagram illustrating an example process 800 performed, for example, by a UE, in accordance with various aspects of the present disclosure. Example process 800 is an example where the UE (e.g., UE 120 and/or the like) performs operations associated with reference signal or precoder indication for a group of component carriers.

As shown in FIG. 8, in some aspects, process 800 may include receiving an indication relating to at least one of a reference signal or a precoder configuration, wherein the indication applies to multiple component carriers (CCs) (block 810). For example, the UE (e.g., using antenna 252, DEMOD 254, MIMO detector 256, receive processor 258, controller/processor 280, and/or the like) may receive an indication relating to at least one of a reference signal or a precoder configuration, as described above. In some aspects, the indication applies to multiple CCs.

As further shown in FIG. 8, in some aspects, process 800 may include determining respective configurations for communications on the multiple CCs in accordance with the indication (block 820). For example, the UE (e.g., using controller/processor 280 and/or the like) may determine respective configurations for communications on the multiple CCs in accordance with the indication, as described above.

As further shown in FIG. 8, in some aspects, process 800 may include performing the communications on the multiple CCs in accordance with the indication (block 830). For example, the UE (e.g., using controller/processor 280, transmit processor 264, TX MIMO processor 266, MOD 254, antenna 252, and/or the like) may perform the communications on the multiple CCs in accordance with the indication, as described above.

Process 800 may include additional aspects, such as any single aspect or any combination of aspects described below and/or in connection with one or more other processes described elsewhere herein.

In a first aspect, the reference signal comprises a demodulation reference signal (DMRS).

In a second aspect, alone or in combination with the first aspect, the indication indicates a DMRS port for the multiple CCs.

In a third aspect, alone or in combination with one or more of the first and second aspects, the indication indicates a number of codewords for a downlink on the multiple CCs.

In a fourth aspect, alone or in combination with one or more of the first through third aspects, the indication indicates a DMRS sequence initialization for the multiple CCs.

In a fifth aspect, alone or in combination with one or more of the first through fourth aspects, process 800 includes receiving information identifying the multiple CCs to which the indication applies.

In a sixth aspect, alone or in combination with one or more of the first through fifth aspects, the indication applies to the multiple CCs based at least in part on the multiple CCs being scheduled by a same downlink control information (DCI).

In a seventh aspect, alone or in combination with one or more of the first through sixth aspects, process 800 includes receiving configuration information pertaining to the multiple CCs, wherein the configuration information is relating to at least one of: whether a transform precoder is being enabled for the multiple CCs, a demodulation reference signal type or length for the multiple CCs, or a maximum number of codewords is scheduling by downlink control information for the multiple CCs.

In an eighth aspect, alone or in combination with one or more of the first through seventh aspects, the indication indicates, for the precoder configuration and the multiple CCs, a per-CC transmitted precoding matrix indicator.

In a ninth aspect, alone or in combination with one or more of the first through eighth aspects, the per-CC transmitted precoding matrix indicator identifies respective transmitted precoding matrix indicators for the multiple CCs based at least in part on a value of the indication that corresponds to a table entry identifying the respective transmitted precoding matrix indicators.

In a tenth aspect, alone or in combination with one or more of the first through ninth aspects, the indication indicates, for the precoder configuration and the multiple CCs, a per-CC sounding reference signal (SRS) resource indicator.

In an eleventh aspect, alone or in combination with one or more of the first through tenth aspects, the per-CC SRS resource indicator identifies respective SRS resource indicators for the multiple CCs based at least in part on a value of the indication that corresponds to a table entry identifying the respective SRS resource indicators.

In a twelfth aspect, alone or in combination with one or more of the first through eleventh aspects, process 800 includes receiving configuration information pertaining to the multiple CCs, wherein the configuration information is relating to at least one of: a codebook subset restriction for the precoder configuration, a maximum rank for the precoder configuration, a full power transmission (FPTX) mode for the precoder configuration, a sounding reference signal (SRS) resource indicator for the precoder configuration, a rank or number of layers associated with the multiple CCs, or a rank or number of layers associated with an SRS.

In a thirteenth aspect, alone or in combination with one or more of the first through twelfth aspects, the indication indicates, for the precoder configuration and the multiple CCs, a common transmitted precoding matrix indicator.

In a fourteenth aspect, alone or in combination with one or more of the first through thirteenth aspects, the indication indicates, for the precoder configuration and the multiple CCs, a common sounding reference signal (SRS) resource indicator.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with various aspects of the present disclosure. Example process 900 is an example where the base station (e.g., BS 110 and/or the like) performs operations associated with reference signal or precoder indication for a group of component carriers.

As shown in FIG. 9, in some aspects, process 900 may include transmitting an indication relating to at least one of a reference signal or a precoder configuration, wherein the indication applies to multiple CCs, wherein the indication indicates respective configurations for communications on the multiple CCs (block 910). For example, the base station (e.g., using controller/processor 240, transmit processor 220, TX MIMO processor 230, MOD 232, antenna 234, and/or the like) may transmit an indication relating to at least one of a reference signal or a precoder configuration, as described above. In some aspects, the indication applies to multiple CCs. In some aspects, the indication indicates respective configurations for communications on the multiple CCs.

As further shown in FIG. 9, in some aspects, process 900 may include performing, with a UE, the communications on the multiple CCs in accordance with the indication (block 920). For example, the base station (e.g., using controller/processor 240, transmit processor 220, TX MIMO processor 230, MOD 232, antenna 234, and/or the like) may perform, with a UE, the communications on the multiple CCs in accordance with the indication, as described above.

Process 900 may include additional aspects, such as any single aspect or any combination of aspects described below and/or in connection with one or more other processes described elsewhere herein.

In a first aspect, the reference signal comprises a demodulation reference signal (DMRS).

In a second aspect, alone or in combination with the first aspect, the indication indicates a DMRS port for the multiple CCs.

In a third aspect, alone or in combination with one or more of the first and second aspects, the indication indicates a number of codewords for a downlink on the multiple CCs.

In a fourth aspect, alone or in combination with one or more of the first through third aspects, the indication indicates a DMRS sequence initialization for the multiple CCs.

In a fifth aspect, alone or in combination with one or more of the first through fourth aspects, process 900 includes transmitting information identifying the multiple CCs to which the indication applies.

In a sixth aspect, alone or in combination with one or more of the first through fifth aspects, the indication applies to the multiple CCs based at least in part on the multiple CCs being scheduled by a same downlink control information (DCI).

In a seventh aspect, alone or in combination with one or more of the first through sixth aspects, process 900 includes transmitting configuration information pertaining to the multiple CCs, wherein the configuration information is relating to at least one of: whether a transform precoder is being enabled for the multiple CCs, a demodulation reference signal type or length for the multiple CCs, or a maximum number of codewords is scheduling by downlink control information for the multiple CCs.

In an eighth aspect, alone or in combination with one or more of the first through seventh aspects, the indication indicates, for the precoder configuration and the multiple CCs, a per-CC transmitted precoding matrix indicator.

In a ninth aspect, alone or in combination with one or more of the first through eighth aspects, the per-CC transmitted precoding matrix indicator identifies respective transmitted precoding matrix indicators for the multiple CCs based at least in part on a value of the indication that corresponds to a table entry identifying the respective transmitted precoding matrix indicators.

In a tenth aspect, alone or in combination with one or more of the first through ninth aspects, the indication indicates, for the precoder configuration and the multiple CCs, a per-CC sounding reference signal (SRS) resource indicator.

In an eleventh aspect, alone or in combination with one or more of the first through tenth aspects, the per-CC SRS resource indicator identifies respective SRS resource indicators for the multiple CCs based at least in part on a value of the indication that corresponds to a table entry identifying the respective SRS resource indicators.

In a twelfth aspect, alone or in combination with one or more of the first through eleventh aspects, process 900 includes receiving configuration information pertaining to the multiple CCs, wherein the configuration information is relating to at least one of: a codebook subset restriction for the precoder configuration, a maximum rank for the precoder configuration, a full power transmission (FPTX) mode for the precoder configuration, a sounding reference signal (SRS) resource indicator for the precoder configuration, a maximum number of layers or a rank for the precoder configuration, or a maximum number of layers or a rank for an SRS.

In a thirteenth aspect, alone or in combination with one or more of the first through twelfth aspects, the indication indicates, for the precoder configuration and the multiple CCs, a common transmitted precoding matrix indicator.

In a fourteenth aspect, alone or in combination with one or more of the first through thirteenth aspects, the indication indicates, for the precoder configuration and the multiple CCs, a common sounding reference signal (SRS) resource indicator.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a user equipment (UE), comprising:
receiving an indication relating to at least one of a reference signal or a precoder configuration, wherein the indication applies to multiple component carriers (CCs);
determining respective configurations for communications on the multiple CCs in accordance with the indication; and
performing the communications on the multiple CCs in accordance with the indication.

2. The method of claim 1, wherein the reference signal comprises a demodulation reference signal (DMRS).

3. The method of claim 2, wherein the indication indicates a DMRS port for the multiple CCs.

4. The method of claim 2, wherein the indication indicates a number of codewords for a downlink on the multiple CCs.

5. The method of claim 2, wherein the indication indicates a DMRS sequence initialization for the multiple CCs.

6. The method of claim 1, further comprising:
receiving information identifying the multiple CCs to which the indication applies.

7. The method of claim 1, wherein the indication applies to the multiple CCs based at least in part on the multiple CCs being scheduled by a same downlink control information (DCI).

8. The method of claim 1, further comprising:
receiving configuration information pertaining to the multiple CCs, wherein the configuration information relates to at least one of:
whether a transform precoder is enabled for the multiple CCs,
a demodulation reference signal type or length for the multiple CCs, or
a maximum number of codewords scheduled by downlink control information for the multiple CCs.

9. The method of claim 1, wherein the indication indicates, for the precoder configuration and the multiple CCs, a per-CC transmitted precoding matrix indicator.

10. The method of claim 9, wherein the per-CC transmitted precoding matrix indicator identifies respective transmitted precoding matrix indicators for the multiple CCs based at least in part on a value of the indication that corresponds to a table entry identifying the respective transmitted precoding matrix indicators.

11. The method of claim 1, wherein the indication indicates, for the precoder configuration and the multiple CCs, a per-CC sounding reference signal (SRS) resource indicator.

12. The method of claim 11, wherein the per-CC SRS resource indicator identifies respective SRS resource indicators for the multiple CCs based at least in part on a value of the indication that corresponds to a table entry identifying the respective SRS resource indicators.

13. The method of claim 1, further comprising:
receiving configuration information pertaining to the multiple CCs, wherein the configuration information relates to at least one of:
a codebook subset restriction for the precoder configuration,
a maximum rank for the precoder configuration,
a full power transmission (FPTX) mode for the precoder configuration,
a sounding reference signal (SRS) resource indicator for the precoder configuration,
a rank or number of layers associated with the multiple CCs, or
a rank or number of layers associated with an SRS.

14. The method of claim 1, wherein the indication indicates, for the precoder configuration and the multiple CCs, a common transmitted precoding matrix indicator.

15. The method of claim 1, wherein the indication indicates, for the precoder configuration and the multiple CCs, a common sounding reference signal (SRS) resource indicator.

16. A method of wireless communication performed by a base station, comprising:
transmitting an indication relating to at least one of a reference signal or a precoder configuration, wherein the indication applies to multiple component carriers (CCs), wherein the indication indicates respective configurations for communications on the multiple CCs; and
performing, with a user equipment (UE), the communications on the multiple CCs in accordance with the indication.

17. The method of claim 16, wherein the reference signal comprises a demodulation reference signal (DMRS).

18. The method of claim 17, wherein the indication indicates a DMRS port for the multiple CCs.

19. The method of claim 17, wherein the indication indicates a number of codewords for a downlink on the multiple CCs.

20. The method of claim 17, wherein the indication indicates a DMRS sequence initialization for the multiple CCs.

21. The method of claim 16, further comprising:
transmitting information identifying the multiple CCs to which the indication applies.

22. The method of claim 16, wherein the indication applies to the multiple CCs based at least in part on the multiple CCs being scheduled by a same downlink control information (DCI).

23. The method of claim 16, further comprising:
transmitting configuration information pertaining to the multiple CCs, wherein the configuration information relates to at least one of:
whether a transform precoder is enabled for the multiple CCs,
a demodulation reference signal type or length for the multiple CCs, or
a maximum number of codewords scheduled by downlink control information for the multiple CCs.

24. The method of claim 16, wherein the indication indicates, for the precoder configuration and the multiple CCs, a per-CC transmitted precoding matrix indicator.

25. The method of claim 24, wherein the per-CC transmitted precoding matrix indicator identifies respective transmitted precoding matrix indicators for the multiple CCs based at least in part on a value of the indication that corresponds to a table entry identifying the respective transmitted precoding matrix indicators.

26. The method of claim 16, wherein the indication indicates, for the precoder configuration and the multiple CCs, a per-CC sounding reference signal (SRS) resource indicator.

27. The method of claim 26, wherein the per-CC SRS resource indicator identifies respective SRS resource indicators for the multiple CCs based at least in part on a value of the indication that corresponds to a table entry identifying the respective SRS resource indicators.

28. The method of claim 16, further comprising:
transmitting configuration information pertaining to the multiple CCs, wherein the configuration information relates to at least one of:
a codebook subset restriction for the precoder configuration,
a maximum rank for the precoder configuration,
a full power transmission (FPTX) mode for the precoder configuration,
a sounding reference signal (SRS) resource indicator for the precoder configuration,
a maximum number of layers or a rank for the precoder configuration, or
a maximum number of layers or a rank for an SRS.

29. The method of claim 16, wherein the indication indicates, for the precoder configuration and the multiple CCs, a common transmitted precoding matrix indicator.

30. The method of claim 16, wherein the indication indicates, for the precoder configuration and the multiple CCs, a common sounding reference signal (SRS) resource indicator.

31. A user equipment (UE) for wireless communication, comprising:
a memory; and
one or more processors operatively coupled to the memory, the memory and the one or more processors configured to:
receive an indication relating to at least one of a reference signal or a precoder configuration, wherein the indication applies to multiple component carriers (CCs);
determine respective configurations for communications on the multiple CCs in accordance with the indication; and
perform the communications on the multiple CCs in accordance with the indication.

32. A base station for wireless communication, comprising:
a memory; and
one or more processors operatively coupled to the memory, the memory and the one or more processors configured to:
transmit an indication relating to at least one of a reference signal or a precoder configuration, wherein the indication applies to multiple component carriers (CCs), wherein the indication indicates respective configurations for communications on the multiple CCs; and
perform, with a user equipment (UE), the communications on the multiple CCs in accordance with the indication.

33. (canceled)

34. (canceled)

35. An apparatus for wireless communication, comprising:
means for receiving an indication relating to at least one of a reference signal or a precoder configuration, wherein the indication applies to multiple component carriers (CCs);
means for determining respective configurations for communications on the multiple CCs in accordance with the indication; and
means for performing the communications on the multiple CCs in accordance with the indication.

36. (canceled)
